(19) United States
(12) Patent Application Publication
(10) Pub. No.: US 2026/0246030 A1
(43) Pub. Date: Aug. 20, 2026

(54) POUCH SEALING DEVICE AND POUCH SEALING METHOD

(71) Applicant: LG ENERGY SOLUTION, LTD., Seoul (KR)

(72) Inventor: Dong Min KANG, Daejeon (KR)

(73) Assignee: LG ENERGY SOLUTION, LTD., Seoul (KR)

(21) Appl. No.: 19/145,070

(22) PCT Filed: Aug. 5, 2024
(86) PCT No.: PCT/KR2024/011493

§ 371 Date: Jul. 1, 2025

(30) Foreign Application Priority Data
Aug. 14, 2023 (KR) 10-2023-0106025

(51) Int. Cl. H01M 50/105

(52) U.S. Cl. CPC H01M 50/105

(57) ABSTRACT

A pouch sealing device including a sealer configured to seal a sealing target region of one of a plurality of edge portions of a pouch in which an electrode assembly is accommodated, a cooler configured to cool a cooling target region of the pouch located between an internal space of the pouch in which the electrode assembly is accommodated and the sealing target region, and a controller configured to control the cooler to perform a pre-cooling mode in which the cooling target region is cooled and thereafter control the sealer to perform a sealing mode in which the sealing target region is heated.

### DESCRIPTION

### Technical Field

The present invention relates to a pouch sealing device and a pouch sealing method, and more particularly, relates to a pouch sealing device and a pouch sealing method for pre-cooling a periphery of a sealing target region of a pouch where sealing is required, and then sealing the sealing target region.

This application claims the benefit of priority based on Korean Patent Application No. 10-2023-0106025 dated Aug. 14, 2023, the disclosure of which is incorporated herein by reference in its entirety.

### Background Art

FIG. 1 is a schematic diagram showing a conventional pouch sealing process.

As shown in FIG. 1, a battery cell (10) for a secondary battery comprises an electrode assembly (20) and a pouch (30).

The electrode assembly (20) may be formed in a laminated form with a separator interposed between one or more positive electrodes and one or more negative electrodes.

The pouch (30) is a case for protecting the electrode assembly (20). The electrode assembly (20) is accommodated in the internal space (31) of the pouch (30). In addition, the pouch (30) has a sealed edge portion (32) surrounding the internal space (31).

The edge portion (32) of the pouch (30) is sealed by a sealing member (1) so that the internal space (31) of the pouch (30) is sealed. A sealing target region (60) sealed by the sealing member (1) is provided for each edge portion (32) of the pouch (30).

In addition, the sealing member (1) is provided to thermally fuse the edge portion (32) of the pouch (30) by providing heat (Q) while pressurizing the sealing target region (60)

However, in the process that the sealing member (1) seals the edge portion (32) of the pouch (30), the heat (Q) of the sealing member (1) is transferred to the periphery of the sealing target region (60). The adhesive layer of the pouch (30) is melted not only in the sealing target region (60) but also in the peripheral region of the sealing target region (60) by the heat (Q) provided from the sealing member (1).

Particularly, if the inner side peripheral region (50) adjacent to the electrode assembly (20) among the peripheral regions of the sealing target region (60) is temporarily attached by the heat (Q) of the sealing member (1), it can directly affect the electrode assembly (20) and cause a defect in the battery cell (10).

### DISCLOSURE

### Technical Problem

The present invention is intended to provide a pouch sealing device and a pouch sealing method for pre-cooling a periphery of a sealing target region of a pouch where sealing is required, and then sealing the sealing target region of the pouch.

In addition, the present invention is intended to provide a pouch sealing device and a pouch sealing method capable of pre-cooling an inner side peripheral region of a pouch extended from a sealing target region to an internal space of the pouch to prevent temporary attachment of the inner side peripheral region by heat conduction upon sealing of the pouch.

### Technical Solution

A pouch sealing device comprises a sealer configured to seal a sealing target region of one edge portion of a plurality of edge portions of a pouch in which an electrode assembly is accommodated, a cooler configured to cool a cooling target region of the pouch located between an internal space of the pouch in which the electrode assembly is accommodated and the sealing target region, and a controller configured to control the cooler to perform a pre-cooling mode in which the cooling target region is cooled and thereafter control the sealer to perform a sealing mode in which the sealing target region is heated.

Also, the cooling target region of the pouch may extend from the sealing target region toward the internal space of the pouch.

In addition, the cooler may comprise a first cooling body disposed parallel to a length direction of the one edge portion of the pouch and configured to contact the cooling target region.

Furthermore, the first cooling body may comprise a Peltier element.

Also, the first cooling body may have a bar shape having a length longer than a length of the one edge portion.

In addition, the cooler may comprise a second cooling body disposed symmetrically to face with the first cooling body on opposite sides of the cooling target region.

Furthermore, the first cooling body and the second cooling body may each be provided to be movable in a direction closer to or farther away from each other.

Also, the second cooling body may comprise a Peltier element.

In addition, the second cooling body may have a bar shape having a length longer than the length of the one edge portion.

Furthermore, the first cooling body and second cooling body may be arranged symmetrically to face each other in an up and down direction on opposite sides the cooling target region.

Also, the sealing part may comprise a first sealing body and a second sealing body disposed symmetrically to face each other on opposite sides of the sealing target region and configured to heat the sealing target region vertically during the sealing mode.

In addition, the first sealing body and the second sealing body may be configured to seal the one edge portion of the pouch in the form of a line having a predetermined width. Each sealing body may have a bar shape, and may comprise a heater for applying heat to the sealing target region.

Furthermore, the first sealing body and the second sealing body may each be disposed to be spaced apart from the sealing target region of the pouch during the pre-cooling mode.

Also, the first sealing body and the second sealing body may each have a bar shape having a length longer than the length of the edge portion of the pouch and may be configured to be movable in a direction closer to or farther away from each other.

In addition, the controller may be configured to repeatedly perform the sealing mode after the pre-cooling mode for each remaining edge portion of the plurality of edge portions of the pouch.

Furthermore, a pouch sealing method related to one example of the present invention is a pouch sealing method using the pouch sealing device, which comprises a pre-cooling step of cooling the cooling target region extending inwardly from the one edge portion of the pouch, and a sealing step of sealing the sealing target region of the edge portion after the pre-cooling step is completed.

### Advantageous Effects

As described above, the pouch sealing device and the pouch sealing method related to one example of the present invention have the following effects.

Before sealing any one edge portion provided on the pouch, the inner side peripheral region of the pouch between the sealing target region to be sealed and the internal space of the pouch is pre-cooled to prevent heat of the sealing part from being transferred to the inner side peripheral region of the pouch, whereby it is possible to prevent damage to the pouch due to heat conduction of the sealing part.

In addition, by pre-cooling the inner side peripheral region of the pouch as the cooling target region, only the sealing target region can be thermally fused upon sealing the pouch, and it is possible to prevent temporary attachment of the inner side peripheral region of the pouch.

### DESCRIPTION OF DRAWINGS

FIG. 1 is a schematic diagram showing a conventional pouch sealing process.

FIG. 2 is a configuration diagram of a pouch sealing device according to one example of the present invention.

FIG. 3 is a plan view showing a cooling target region and a sealing target region of a battery cell in one example of the present invention.

FIG. 4 is an operation state diagram of a cooling part according to one example of the present invention.

FIG. 5 is a plan view showing a state where a first cooling member is seated on a cooling target region.

FIG. 6 is an operation state diagram of a sealing part according to one example of the present invention.

FIG. 7 is a plan view showing a state where a first sealing member is seated on a sealing target region of a pouch.

FIG. 8 is a plan view of a battery cell on which a long-side sealing line is formed.

FIGS. 9 to 11 are schematic diagrams for explaining a process in which a pouch sealing device seals piercing sites provided in a gas pocket of a pouch in a gas removal process.

### MODE FOR INVENTION

Hereinafter, with reference to the attached drawings, a pouch sealing device and a pouch sealing method according to one example of the present invention will be described.

In addition, regardless of the reference numerals, the same or corresponding components are given by the same or similar reference numerals, duplicate descriptions thereof will be omitted, and for convenience of explanation, the size and shape of each component member as shown can be exaggerated or reduced.

FIG. 2 is a configuration diagram of a pouch sealing device according to one example of the present invention, and FIG. 3 is a plan view showing a cooling target region and a sealing target region of a battery cell in one example of the present invention.

A pouch sealing device (100) related to one example of the present invention comprises a sealing part (130) provided to seal a sealing target region (60) of any one edge portion (32) of a plurality of edge portions (32) of a pouch (30) in which an electrode assembly (20) is accommodated.

In this document, the battery cell (10) is a battery cell (10) for a secondary battery, which comprises an electrode assembly (20), a pair of lead tabs (21) electrically connected to the electrode assembly (20), and a pouch (30) surrounding the electrode assembly (20).

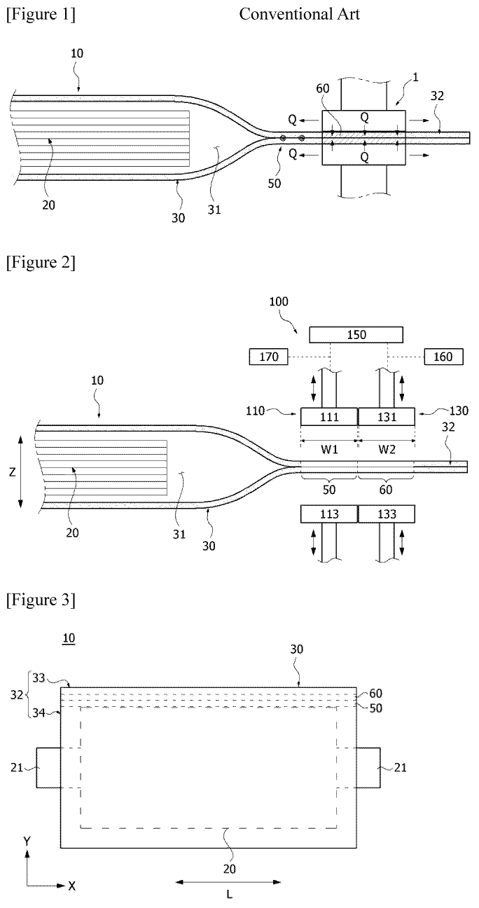

As described through FIG. 1, the electrode assembly (20) may be formed in a laminated form with a separator interposed between one or more positive electrodes and one or more negative electrodes.

The pouch (30) is a case for protecting an electrode assembly (20). The electrode assembly (20) is accommodated in the internal space (31) of the pouch (30). The pouch (30) has a plurality of edge portions (32) provided to surround the internal space (31).

The respective edge portions (32) of the pouch (30) are sealed by the sealing part (130) so that the internal space (31) of the pouch (30), in which the electrode assembly (20) is accommodated, is sealed. The pouch (30) may be formed of an aluminum material, and comprise an adhesive layer. The adhesive layer may be formed of a resin material (e.g., polypropylene material), where the edge portion (32) of the pouch (30) may be sealed while the adhesive layer is melted by the sealing part (130).

Here, the plurality of edge portions (32) of the pouch (30) may comprise long-side edge portions (33) or short-side edge portions (34). For example, upon the sealing mode of the pouch (30), a sealing process may be performed on one long-side edge portion (33) and a pair of short-side edge portions (34).

In this document, the long-side edge portion (33) may be an edge portion extended along a direction (L) connecting a pair of lead tabs (21), and the short-side edge portion (34) may be an edge portion in which the lead tabs (21) protrude outside the pouch (30). Referring to FIG. 3, the edge portion parallel to the x-axis direction may be the long-side edge portion (33), and the edge portion parallel to the y-axis direction may be the short-side edge portion (34).

In addition, the pouch sealing device (100) may be used in a process of sealing the edge portion (32) of the pouch (30) after the electrode assembly (20) is accommodated in the internal space (31, cup portion) of the pouch (30) in an assembly step of the battery cell (10), or may be used in a process of sealing piercing sites (40) provided in the gas pocket (39) of the pouch (30) after an activation process and a gas removal process of the assembled battery cell (1) are performed.

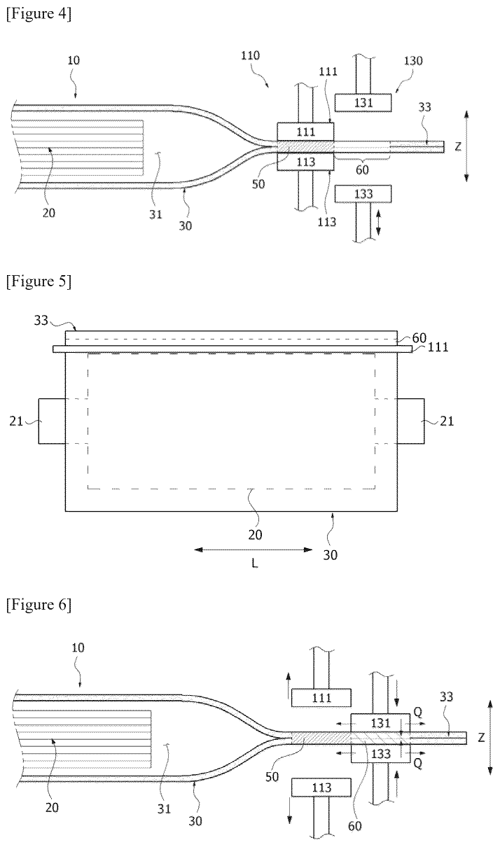

FIG. 4 is an operation state diagram of a cooling part according to one example of the present invention, and FIG. 5 is a plan view showing a state where a first cooling member is seated on a cooling target region.

Also, the pouch sealing device (100) comprises a cooling part (110) provided to cool a cooling target region (50) located between an internal space (31) of a pouch (30) in which an electrode assembly (20) is accommodated and a sealing target region (60).

In addition, the cooling target region (50) of the pouch (30) may extend from the sealing target region (60) toward the internal space (31) of the pouch (30).

The cooling target region (50) may be an inner side peripheral region of the sealing target region (60) in the edge portion (32) of the pouch (30).

Also, the pouch sealing device (100) comprises a control part (150) provided to perform a sealing mode in which the sealing target region (60) is heated through the sealing part (130) after completing a pre-cooling mode in which the cooling target region (50) is cooled through the cooling part (110).

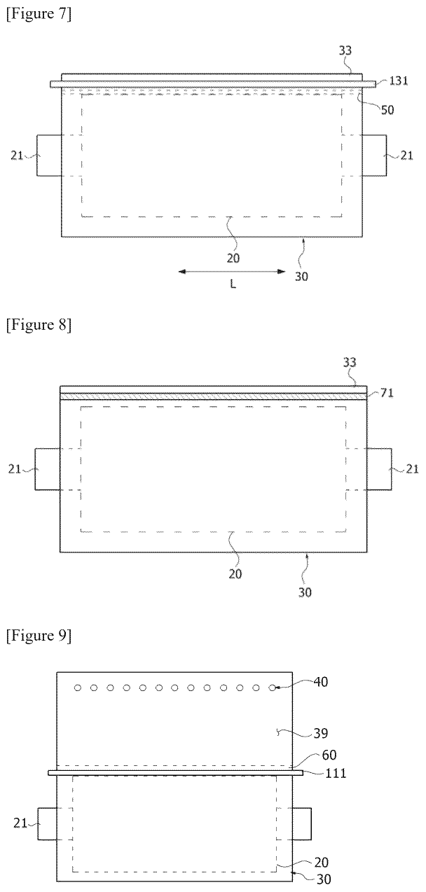

In addition, FIG. 6 is an operation state diagram of a sealing part according to one example of the present invention, FIG. 7 is a plan view showing a state where a first sealing member is seated on a sealing target region of a pouch, and FIG. 8 is a plan view of a battery cell on which a long-side sealing line is formed.

Hereinafter, with reference to FIGS. 2 to 8, a process of sealing the edge portion (32) of the pouch (30) in the assembly step of the battery cell (10) will be described.

The pouch sealing device (100) comprises a cooling part (110) pre-cooling the edge portion of the pouch (30) before the sealing process of the edge portion of the pouch (30).

The cooling part (110) is provided to cool a cooling target region (50) extended from the sealing target region (60) to the inside of the long-side edge portion (33) adjacent to the internal space (31) of the pouch (30) in which the electrode assembly (20) is accommodated.

Referring to FIGS. 2 and 3, the cooling target region (50) may be an inner side peripheral region (50) between the internal space (31) and the sealing target region (60). The cooling target region (50) is a region to be cooled by the cooling part (110).

In this specification, the cooling target region (50) refers to the same site as the inner side peripheral region (50), which uses the same reference numeral.

The cooling part (110) comprises a first cooling member (body) (111) provided to cool the cooling target region (50). In addition, the first cooling member (111) is disposed parallel to the length direction of any one edge portion (32). The first cooling member (111) may have a predetermined width (w1).

The first cooling member (111) is provided to be capable of contacting the cooling target region (50). The first cooling member (111) may have a bar shape having a length longer than the length of the edge portion (32) of the pouch (30). In addition, the first cooling member (111) may comprise a Peltier element. At this time, the Peltier element may comprise an endothermic part and an exothermic part, where the endothermic part may be in contact with the cooling target region (50).

In addition, the cooling part (110) may comprise a second cooling member (body) (113) disposed symmetrically with the first cooling member (111) up and down based on the cooling target region (50).

The second cooling member (113) may be configured in the same manner as the first cooling member (111). The second cooling member (113) may comprise a Peltier element. At this time, the Peltier element may comprise an endothermic part and an exothermic part, where the endothermic part may be in contact with the cooling target region (50).

Also, the first and second cooling members (111, 113) may be disposed to be spaced apart from each other vertically in the laminating direction (Z) of the electrode assembly (20). In addition, the first and second cooling members (111, 113) are provided to be capable of elevating along the laminating direction (Z) of the electrode assembly (20). The cooling part (110) may comprise a first drive part (170) for elevating the first and second cooling members (111, 113). The first drive part (170) may be configured to include a cylinder or a motor.

In addition, upon the pre-cooling mode, the first and second cooling members (111, 113) may each be moved to contact the cooling target region (50). Thereafter, the first and second cooling members (111, 113) may cool the cooling target region (50). Upon the pre-cooling mode, the first and second cooling members (111, 113) may each contact the cooling target region (50) up and down. Furthermore, upon the pre-cooling mode, the first and second cooling members (111, 113) may pressurize the cooling target region (50) up and down.

Furthermore, upon the pre-cooling mode, the temperature of the cooling target region (50) may be lowered by approximately 5° C. to 10° C. compared to a process temperature by the first and second cooling members (111, 113).

Also, before the sealing mode of the sealing part (130) is performed, the inner side peripheral region (50) of the pouch (30) between the sealing target region (60) to be sealed and the internal space (31) of the pouch (30) is pre-cooled as the cooling target region (50), whereby it may be delayed that the heat (Q) of the sealing part (130) is transferred to the inner side peripheral region (50) of the pouch (30).

In addition, the sealing mode may be performed after the pre-cooling mode is completed. Upon the sealing mode, the first and second cooling members (111, 113) may be separated from the cooling target region (50), thereby being disposed to be spaced apart from the cooling target region (50) up and down.

Furthermore, the pouch sealing device (100) comprises a sealing part (130) provided to seal a sealing target region (60) of the pouch (30). Here, the sealing target region (60) is a region where any one edge portion (32) of the pouch (30) is to be sealed by the sealing part (130).

As described above, as any one edge portion (32), a long-side edge portion (33) or a short-side edge portion (34) may be corresponded thereto.

Referring to FIGS. 2 and 6, the sealing part (130) may be disposed symmetrically up and down based on the sealing target region (60). The sealing part (130) may comprise first and second sealing members (bodies) (131, 133).

As shown in FIG. 6, the first and second sealing members (131, 133) may have a bar shape extending along the edge portion (32) of the pouch (30), and the first and second sealing members (131, 133) may have a bar shape having a length longer than the length of the edge portion (32) of the pouch (30). The first and second sealing members (131, 133) may have a predetermined width (w2).

Also, the first and second sealing members (131, 133) are provided to be capable of elevating along the laminating direction (Z) of the electrode assembly (20). The sealing part (130) may comprise a second drive part (160) for moving the first and second sealing members (131, 133) up and down. The second drive part (160) may be configured to include a cylinder or a motor.

Upon the pre-cooling mode of the cooling part (110), the first and second sealing members (131, 133) may be disposed to be spaced apart from each other above and below the sealing target region (60).

In addition, after the pre-cooling mode is completed, upon the sealing mode, the first and second sealing members (131, 133) are moved to contact the sealing target region (60). Thereafter, the first and second sealing members (131, 133) may heat the sealing target region (60) up and down. That is, upon the sealing mode, the first and second sealing members (131, 133) may pressurize and heat the sealing target region (60) up and down.

Accordingly, the sealing target region (60) may be thermally fused by the heat (Q) of the sealing part (130). The long-side edge portion (33) may be sealed by the first and second sealing members (131, 133), and a long-side sealing line (71) may be provided in the pouch (30).

Upon the sealing mode, the first and second sealing members (131, 133) heat and pressurize the sealing target region (60), thereby being capable of sealing any one edge portion (32).

At this time, the pre-cooled cooling target region (50) is in a state where the temperature is lower than that of other portions of the edge portion (32), whereby even if the heat (Q) generated when the sealing part (130) seals the sealing target region (60) is transferred, the temperature rise is delayed, so that upon the sealing mode by the sealing part (130), the portion adjacent to the internal space (31) of the pouch (30) can be prevented from being temporarily attached due to heat conduction.

Also, the pouch sealing device (100) according to one example of the present invention comprises a control part (150) provided to perform a sealing mode in which the sealing part (130) heats the sealing target region (60) after the pre-cooling mode in which the cooling part (110) cools the cooling target region (50). The control part (150) may be provided to control the cooling part (110) and the sealing part (130), and may be provided to control the first and second drive parts (160, 170).

In addition, the control part (150) allows the cooling part (110) to cool the cooling target region (50) until the temperature of the cooling target region (50) reaches a preset cooling temperature.

The control part (150) may cause the cooling part (110) to cool the cooling target region (50) until the temperature of the cooling target region (50) drops to 5° C. to 10° C. below the process temperature. Before cooling, the temperature of the cooling target region (50) may be approximately 23° C., which is the process temperature (atmospheric temperature). However, the cooling temperature of the pouch (30) may vary depending on the specifications of the pouch (30) for each product.

The control part (150) is provided so that the sealing part (130) seals the sealing target region (60) at a preset sealing temperature. The sealing temperature of the sealing part (130) may be in a range of 105° C. to 125° C. However, the sealing temperature of the pouch (30) may vary depending on the specifications of the pouch (30) for each product.

In addition, the control part (150) may repeatedly perform the sealing mode after the pre-cooling mode for each edge portion (32) of the pouch (30).

In this document, an example of sealing the long-side edge portion (33) has been shown, but such a process may also be performed on the short-side edge portion (34) to seal the short-side edge portion (34).

FIGS. 9 to 11 are schematic diagrams for explaining a process in which a pouch sealing device seals piercing sites provided in a gas pocket of a pouch in a gas removal process.

The gas removal process is a process for removing gas generated upon an activation process of the battery cell. To remove gas inside the battery cell (10), some regions of the gas pocket (39) of the pouch (30) are pierced, and the gas is vented to the outside of the battery cell through the piercing sites (40). In the gas removal process, after the gas inside the battery cell (10) is removed, a sealing process for partitioning the internal space where the electrode assembly (20) is accommodated and the piercing sites (40) is performed.

The pouch sealing device (100) may seal the gas pocket (39) in the same manner as the process of sealing the edge portion (32) of the pouch (30) as described above.

Referring to FIG. 9, the first cooling member (111) is in contact with the cooling target region (50) of the pouch (30) between the sealing target region (60) and the electrode assembly (20) to cool the cooling target region (50). When the cooling target region (50) is pre-cooled to a preset cooling temperature, the first cooling member (111) is separated from the cooling target region (50).

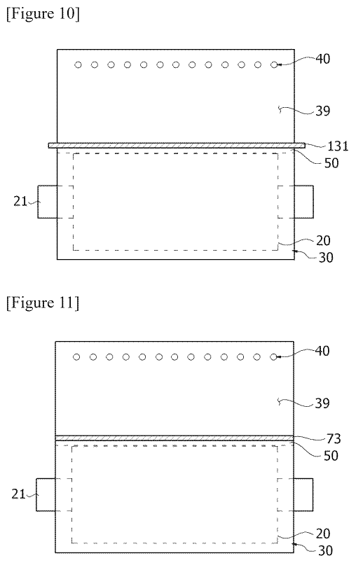

Referring to FIGS. 10 and 11, the first sealing member (131) pressurizes and heats the sealing target region (60) to seal the gas pocket. Accordingly, a pocket sealing line (73) is provided in the gas pocket (39) after the gas removal process. The pocket sealing line (73) is provided to partition the electrode assembly (20) and the piercing portion (40).

The preferred examples of the present invention as described above have been disclosed for illustrative purposes, and those skilled in the art having ordinary knowledge of the present invention will be able to make various modifications, changes, and additions within the spirit and scope of the present invention, and such modifications, changes, and additions should be regarded as falling within the scope of the following claims.

### INDUSTRIAL APPLICABILITY

According to the pouch sealing device and the pouch sealing method related to one example of the present invention, upon sealing the pouch, only the sealing target region can be thermally fused, and the temporary attachment of the inner side peripheral region of the pouch can be prevented.

1. A pouch sealing device comprising:
sealer configured to seal a sealing target region of one edge portion of a plurality of edge portions of a pouch in which an electrode assembly is accommodated;
a cooler configured to cool a cooling target region of the pouch located between an internal space of the pouch in which the electrode assembly is accommodated and the sealing target region; and
a controller configured to control the cooler to perform a pre-cooling mode in which the cooling target region is cooled and thereafter control the sealer to perform a sealing mode in which the sealing target region is heated.

2. The pouch sealing device according to claim 1, wherein the cooling target region of the pouch extends from the sealing target region toward the internal space of the pouch.

3. The pouch sealing device according to claim 1, wherein the cooler comprises a first cooling body disposed parallel to a length direction of the one edge portion of the pouch and configured to contact the cooling target region.

4. The pouch sealing device according to claim 3, wherein the first cooling body comprises a Peltier element.

5. The pouch sealing device according to claim 3, wherein the first cooling body has a bar shape having a length longer than a length of the one edge portion.

6. The pouch sealing device according to claim 3, wherein the cooler further comprises a second cooling body disposed symmetrically to face the first cooling body on opposite sides of the cooling target region, and
wherein the first cooling body and second cooling bodies are each provided to be movable in a direction closer to or farther away from each other.

7. The pouch sealing device according to claim 1, wherein the sealer comprises a first sealing body and a second sealing body disposed symmetrically to face each other on opposite sides of the sealing target region and each are configured to heat the sealing target region vertically during the sealing mode.

8. The pouch sealing device according to claim 7, wherein the first sealing body and the second sealing body are configured to seal the one edge portion of the pouch in the form of a line having a predetermined width.

9. The pouch sealing device according to claim 7, wherein the first sealing body and the second sealing body are configured to be spaced apart from the pouch during the pre-cooling mode.

10. The pouch sealing device according to claim 7, wherein the first sealing body and the second sealing body each have a bar shape having a length longer than a length of the one edge portion of the pouch, and are configured to be movable in a direction closer to or farther away from each other.

11. The pouch sealing device according to claim 1, wherein the controller is configured to repeatedly perform the sealing mode after the pre-cooling mode for each remaining edge portion of the plurality of edge potions of the pouch.

12. A pouch sealing method using the pouch sealing device according to claim 1, comprising:
a pre-cooling step of cooling the cooling target region extending inwardly from the one edge portion of the pouch; and
a sealing step of sealing the sealing target region of the one edge portion after the pre-cooling step is completed.
